(19) United States
(12) Patent Application Publication
(10) Pub. No.: US 2007/0194897 A1
(43) Pub. Date: Aug. 23, 2007

(54) SYSTEM OF DETECTING TIRE INFORMATION

(75) Inventor: Hideki Masudaya, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/673,428

(22) Filed: Feb. 9, 2007

(30) Foreign Application Priority Data
Feb. 13, 2006 (JP) 2006-034949

(51) Int. Cl. B60C 23/00

(52) U.S. Cl. 340/447

(57) ABSTRACT

A system of detecting tire information includes a measured value transmitter mounted in a tire of a vehicle and a controller provided in the body of the vehicle. The measured value transmitter includes an antenna, a resonator, the resonant frequency of which is varied in accordance with a temperature of the tire, and a resistive pressure sensor, the resistance of which is varied in accordance with a pressure in the tire. The controller transmits a signal for resonating the resonator and receives a signal having the resonant frequency of the resonator from the measured value transmitter. The controller calculates the temperature in the tire based on the signal having the resonant frequency. The controller calculates the pressure in the tire based on a signal level of the signal having the resonant frequency.

### CLAIM OF PRIORITY

This application claims benefit of the Japanese Patent Application No. 2006-034949 filed on Feb. 13, 2006, which is hereby incorporated by reference.

### BACKGROUND

1. Field of the Invention

The present invention relates to systems of detecting tire information, and more particularly, to a system of detecting tire information including tire pressure and temperature of an automobile or similar vehicles.

2. Description of the Related Art

Radio transmission systems have been proposed, in which measured values, such as tire pressure, of automobiles or similar vehicles are transmitted by radio waves to controllers provided in the bodies of the automobiles or similar vehicles. The transmitted measured values are evaluated to, for example, send out warning messages to the drivers (for example, refer to U.S. Pat. No. 6,378,360). In such a radio transmission system, a controller shown in FIG. 4 is provided in the body of the vehicle and a measured value transmitter (transponder) shown in FIG. 5 is provided in a tire of the vehicle.

As shown in FIG. 4, the controller includes a carrier wave oscillator G1, a modulator MO1, and an oscillator G2. The carrier wave oscillator G1 generates a carrier wave having a frequency f1 of about 2.4 GHz and supplies the generated carrier wave to the modulator MO1. The oscillator G2 outputs an oscillation signal for modulation. The oscillator G2 supplies the oscillation signal having a frequency f2 close to the resonant frequency of a resonator in the transponder, which is described below, to the modulator MO1. In the modulator MO1, the carrier wave supplied from the carrier wave oscillator G1 is amplitude-modulated in accordance with the oscillation signal supplied from the oscillator G2. The amplitude-modulated high-frequency signal of 2.4 GHz is amplified by an amplifier (not shown) and the amplified high-frequency signal is emitted from an antenna A1 near the tire.

The controller also includes a switch S1, a receiver E1, and a timer T1. The switch S1 is used to switch the availability of the amplitude modulation in the modulator MO1. The receiver E1 receives a high-frequency signal emitted from the transponder to calculate a measured value V1, such as a pressure in the tire. The timer T1 controls the switching timing in the switch S1 and the state of the receiver E1. After the availability of the amplitude modulation of the carrier wave is switched in accordance with the switching timing controlled by the timer T1 and the amplitude-modulated high-frequency signal is transmitted for a predetermined time period, the amplitude modulation is stopped at a time t1. The non-modulated carrier wave is transmitted from the time t1. The receiver E1 is enabled at a time t2 about one millisecond or less after the time t1 to receive the high-frequency signal supplied from the transponder through an antenna A4.

As shown in FIG. 5, the transponder includes a low-pass filter L1/C1, a varactor diode (hereinafter simply referred to as a “diode”) D1, a capacitive pressure sensor (hereinafter simply referred to as a “pressure sensor”) SC1, and a resonator including a crystal oscillator Q1. The diode D1 functions as a modulator-demodulator. The capacitance of the pressure sensor SC1 is varied with the pressure in the tire. The crystal oscillator Q1 is excited by a frequency component included in the high-frequency signal supplied from the controller. The carrier wave of 2.4 GHz is removed from the high-frequency signal supplied from the controller by the low-pass filter L1/C1, and the high-frequency signal is demodulated by the diode D1. As a result, a signal having a frequency equal to that of the oscillation signal supplied from the oscillator G2 is extracted. Because the resonant frequency of the resonator is close to the frequency of the oscillation signal supplied from the oscillator G2, the resonator is excited by the extracted signal. This excitation generates a signal having the resonant frequency. Because the resonant frequency of the resonator is varied with a variation in the capacitance of the pressure sensor SC1 caused by the pressure in the tire, the generated signal having the resonant frequency is also affected by the pressure in the tire.

As described above, after transmitting the amplitude-modulated high-frequency signal, the controller stops the amplitude modulation and transmits the non-modulated carrier wave. The resonator in the transponder continues to oscillate for about one millisecond or more even after the amplitude modulation is stopped. Accordingly, the non-modulated carrier wave supplied from the controller is amplitude-modulated by the diode D1 in accordance with the signal having the resonant frequency of the resonator. The amplitude-modulated signal is emitted from an antenna A3. The receiver E1 in the controller receives the amplitude-modulated high-frequency signal through the antenna A4 and extracts the signal having the resonant frequency through a demodulator (not shown) to calculate the measured value V1, such as the pressure in the tire.

In the radio transmission system disclosed in U.S. Pat. No. 6,378,360, the transponder may further include multiple resonators to transmit measured values including tire pressure, and the controller may calculate the measured values.

However, when the transponder includes multiple resonators to detect multiple measured values, such as tire pressure and tire temperature, there is a problem in that the cost is increased with the increasing number of the resonators.

### BRIEF SUMMARY

According to an exemplary embodiment, a system of detecting tire information includes a measured value transmitter mounted in a tire of a vehicle and a controller provided in the body of the vehicle. The measured value transmitter includes an antenna, a resonator, the resonant frequency of which is varied in accordance with a temperature of the tire, and a resistive pressure sensor, the resistance of which is varied in accordance with a pressure in the tire. The controller transmits a signal for resonating the resonator and receives a signal having the resonant frequency of the resonator from the measured value transmitter. The controller calculates the temperature in the tire based on the signal having the resonant frequency. The controller calculates the pressure in the tire based on a signal level of the signal having the resonant frequency.

Other systems, features, and advantages of the invention will be, or will become, apparent to one with skill in the art upon examination of the following figures and detailed description. It is intended that all such additional systems, features, and advantages be included within this description.

### BRIEF DESCRIPTION OF THE DRAWINGS

The components in the figures are not necessarily to scale, emphasis instead being placed upon illustrating the principles of the invention. Moreover, in the figures, like referenced numerals designate corresponding parts throughout the different views.

FIG. 1 is a schematic illustrating an example of a transponder circuit for a system of detecting tire information;

FIG. 2 is a graph illustrating a difference between the resonant frequency extracted from a signal received from the transponder and the frequency of an oscillation signal from a controller;

FIG. 3 is a graph illustrating the relationship between a resistance in a pressure sensor in the transponder and a predetermined-level reaching time;

FIG. 4 is a schematic illustrating an example of a controller circuit for a system of detecting tire information in the related art; and

FIG. 5 is a schematic illustrating an example of a transponder circuit for the system of detecting tire information in the related art.

### DESCRIPTION OF THE PREFERRED EMBODIMENTS

A system of detecting tire information for a vehicle, according to an exemplary embodiment, includes a controller provided in the body of a vehicle and a measured value transmitter (hereinafter referred to as a “transponder”) mounted in a tire of the vehicle, as in the system of detecting tire information (radio transmission system) described in “Description of the Related Art”.

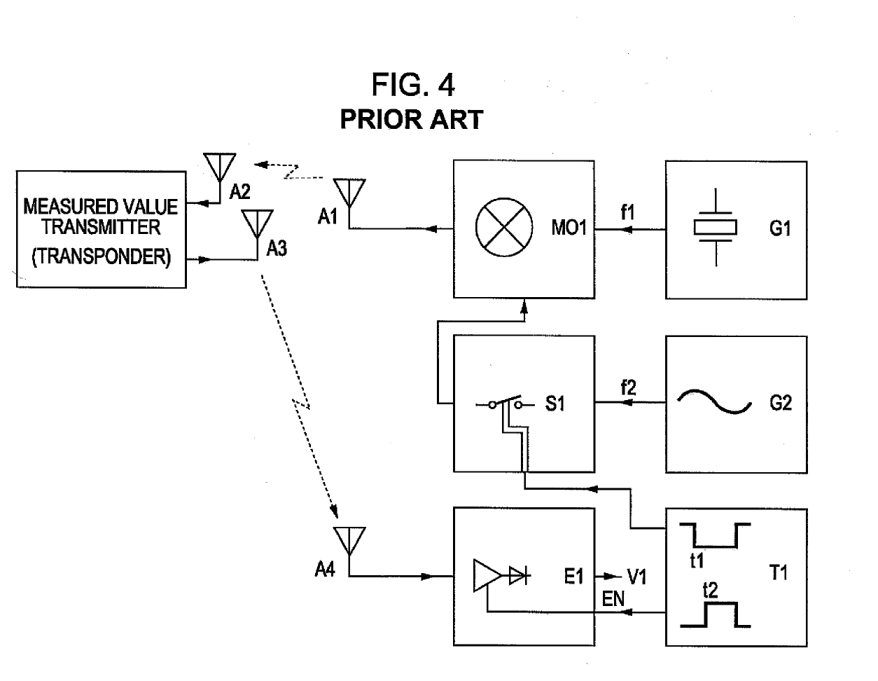

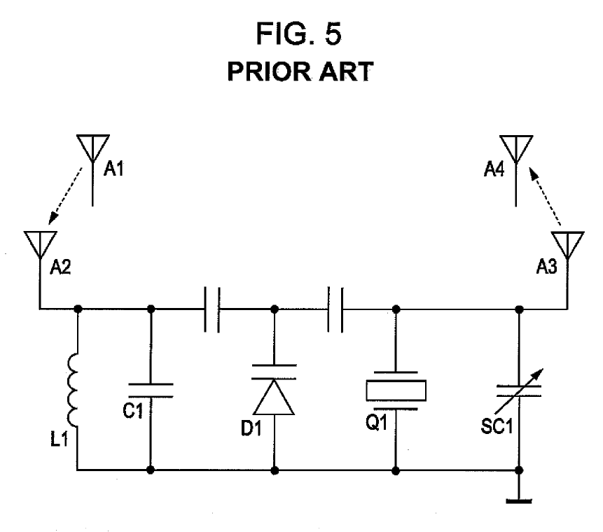

The system of detecting tire information according to the exemplary embodiment differs from the system of detecting tire information in the related art in the configuration of the transponder. Accordingly, the circuit configuration of the transponder in the system of detecting tire information according to the exemplary embodiment will be described in detail. The configuration of the controller will be described only in terms of components that are different from those in FIG. 4.

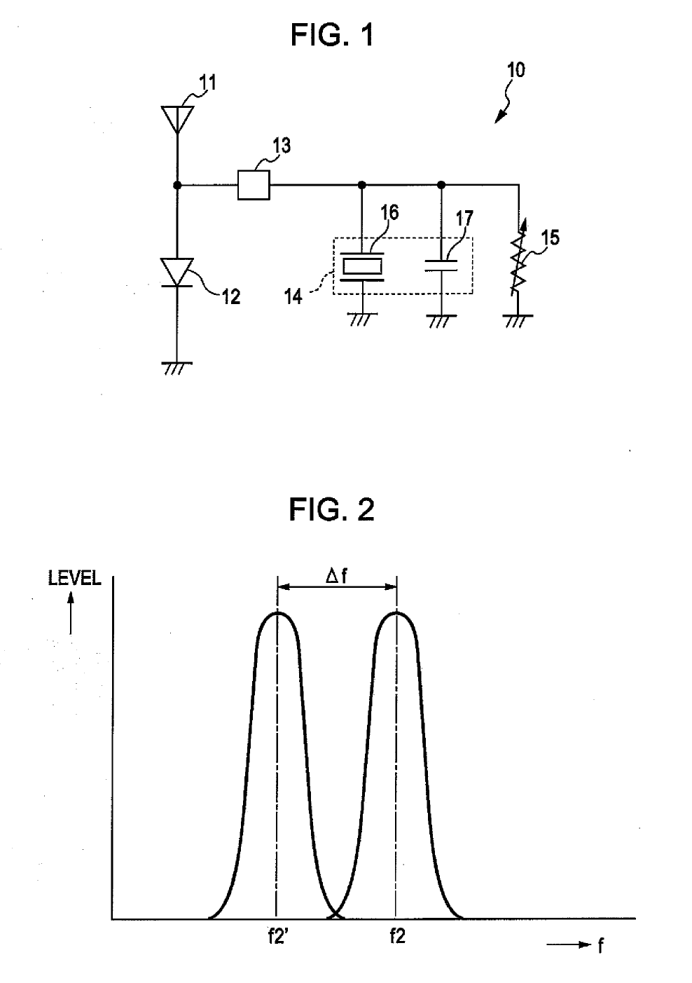

FIG. 1 is a circuit schematic illustrating an example of a transponder 10 for the system of detecting tire information.

As shown in FIG. 1, the transponder 10 includes an antenna 11 for transmission and reception. A diode 12, used for demodulation and modulation, is connected in series to the antenna 11. A low-pass filter 13 is connected to the antenna 11. A resonator 14 and a resistive pressure sensor (hereinafter simply referred to as a “pressure sensor”) 15 are connected to the low-pass filter 13. The resonator 14 is connected in parallel to the pressure sensor 15. Although the low-pass filter 13 is connected to the antenna 11 in the transponder 10 shown in FIG. 1, the circuit configuration of the transponder 10 is not limited to the one shown in FIG. 1. A bandpass filter or the like having a function similar to that of the low-pass filter 13 may be connected to the antenna 11.

The resonator 14 includes a crystal oscillator 16 and a capacitor 17 providing a load capacitance for determining the resonant frequency of the resonator 14. The resonator 14 has a resonant frequency of, for example, 9.800 MHz. The resonant frequency of the resonator 14 is varied with the temperature in the tire.

Also, the electrical resistance (resistance) of the pressure sensor 15 is varied with the pressure in the tire. For example, the resistance in the pressure sensor 15 is increased with the increasing pressure in the tire and is decreased with the decreasing pressure in the tire. A piezoresistive pressure sensor may be used as the pressure sensor 15.

In the controller for the system of detecting tire information according to the exemplary embodiment, the oscillator G2 (referring to FIG. 4) generates an oscillation signal having a frequency f2 close to the resonant frequency of the resonator 14. For example, an oscillation signal having a center frequency of 9.800 MHz and a carrier wave having a frequency f1 is amplitude-modulated in accordance with the oscillation signal. The controller determines a time (hereinafter referred to as a “predetermined-level reaching time”) required for attenuation of a signal level (voltage level) of a signal having the resonant frequency, generated by excitation of the resonator 14, to reach a predetermined level. As described below, the controller determines the predetermined-level reaching time to calculate a pressure in the tire. The availability of the amplitude modulation is controlled by the switch S1.

After the controller amplitude-modulates the carrier wave having the frequency f1 in accordance with the oscillator signal having the frequency f2 (the oscillator signal having a center frequency of 9.800 MHz), generated by the oscillator G2, the amplitude-modulated high-frequency signal having a frequency of 2.4 GHz is emitted from the antenna A1. After the amplitude modulation is stopped at the time t1 shown in FIG. 4, the receiver E1 is enabled at the time t2. At the time when the amplitude modulation is stopped, the non-modulated carrier wave is emitted from the antenna A1.

In the transponder 10, the high-frequency signal of 2.4 GHz subjected to the amplitude modulation in the controller is demodulated by the diode 12, and the carrier wave of 2.4 GHz is removed from the high-frequency signal by the low-pass filter 13. As a result, a signal having a frequency equal to that of the oscillator signal supplied from the oscillator G2 (the oscillator signal having a center frequency of 9.800 MHz) is extracted. Because the resonant frequency of the resonator 14 is close to the frequency of the oscillator signal supplied from the oscillator G2, the resonator 14 is excited with the extracted signal. This excitation generates the signal having the resonant frequency of the resonator 14. Because the resonant frequency of the resonator 14 is varied with the temperature in the tire, the generated signal having the resonant frequency is also affected by the temperature in the tire.

Even when the amplitude modulation is stopped in the controller and the non-modulated carrier wave is emitted, the resonator 14 in the transponder 10 continues to oscillate while being attenuated for a time corresponding to the pressure detected by the pressure sensor 15 after the amplitude modulation is stopped. Accordingly, the non-modulated carrier wave transmitted from the controller is amplitude-modulated by the diode 12 in accordance with the signal having the resonant frequency of the resonator 14, and the amplitude-modulated signal is emitted from the antenna 11. The receiver E1 in the controller receives the amplitude-modulated high-frequency signal through the antenna A4 and extracts the signal having the resonant frequency through, for example, a modulator (not shown) to calculate pressure and temperature in the tire.

In regards to calculation of temperature in the tire, the receiver E1 determines any shift between the frequency f2 of the oscillator signal generated by the oscillator G2 in the controller and the resonant frequency f2′ extracted from the signal received from the transponder 10. Because the resonant frequency of the resonator 14 is varied with a variation of temperature in the tire, the determination of an amount of shift, shown in FIG. 2, between the resonant frequency f2′ and the frequency f2 allows the temperature in the tire to be calculated. It is preferred that, for example, a table indicating the relationship between the shift in the frequency and an amount of variation in the temperature in the tire be prepared in advance for reference in order to calculate the temperature in the tire.

In regards to the calculation of pressure in the tire, the receiver E1 determines a predetermined-level reaching time of the signal having the resonant frequency, which is extracted from the signal received from the transponder 10. Any variation in the pressure in the tire varies the resistance in the pressure sensor 15. The variation in the resistance in the pressure sensor 15 varies the power consumed in the resonator 14, thus varying the predetermined-level reaching time. For example, a higher resistance in the pressure sensor 15 reduces the power consumed in the resonator 14 to provide gradual attenuation of the signal level. As a result, the predetermined-level reaching time is increased compared to a case where the pressure sensor 15 has a lower resistance. A lower resistance in the pressure sensor 15 increases the power consumed in the resonator 14 to provide sharp attenuation of the signal level. As a result, the predetermined-level reaching time is reduced.

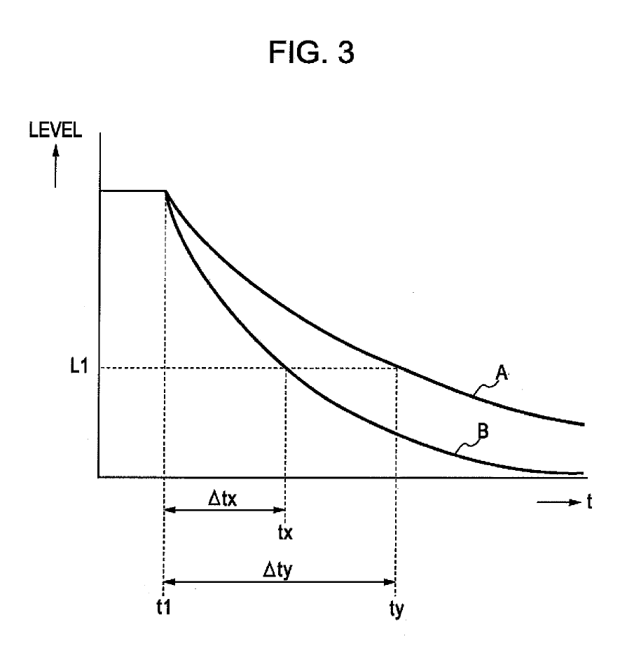

FIG. 3 illustrates the relationship between the resistance in the pressure sensor 15 and the predetermined-level reaching time. When the pressure sensor 15 has a higher resistance, the level of the signal having the resonant frequency of the resonator 14 is gradually attenuated, as shown by curve A in FIG. 3. In contrast, when the pressure sensor 15 has a lower resistance, the level of the signal having the resonant frequency of the resonator 14 is sharply attenuated, as shown by curve B in FIG. 3. The system of detecting tire information according to the exemplary embodiment determines a time (Δty for the curve A and Δtx for the curve B) required for the signal having the resonant frequency to reach a predetermined level L1. Pressure in the tire is calculated on the basis of the length of the predetermined-level reaching time. It is preferred that, for example, a table indicating the relationship between the predetermined-level reaching time and an amount of variation of the pressure in the tire be prepared in advance for reference in order to calculate the pressure in the tire.

As described above, in the system of detecting tire information according to the exemplary embodiment of the present invention, the controller calculates the temperature in the tire on the basis of the signal having the resonant frequency, which is extracted from the signal received from the transponder 10, and calculates the pressure in the tire on the basis of the level of the signal having the resonant frequency. Both the pressure in the tire and the temperature in the tire may be calculated on the basis of the signal received from the single resonator. Consequently, it is possible to accurately detect multiple measured values, such as calculating the pressure and temperature in the tire, while suppressing an increase in cost.

Furtermore, in the transponder 10 for the system of detecting tire information according to the exemplary embodiment, the resonator 14 and the pressure sensor 15 may be connected in parallel to the input and output end of the antenna 11 via the low-pass filter 13. Such connection varies the power consumed in the resonator 14 in accordance with the resistance in the pressure sensor 15. Accordingly, the pressure in the tire can be calculated by determining how the signal having the resonant frequency, which is generated by the resonator 14 whose power consumption is varied, is attenuated.

In the system of detecting tire information according to the exemplary embodiment, the controller calculates the pressure in the tire on the basis of the time (predetermined-level reaching time) required for attenuation of the signal having the resonant frequency, which is extracted from the signal received from the transponder 10, to reach a predetermined level. The determination of the predetermined-level reaching time of the signal having the resonant frequency extracted from the received signal allows the pressure in the tire to be accurately calculated without any additional resonator.

Also, the controller calculates the temperature in the tire on the basis of the difference between the frequency of the signal for resonating the resonator 14 (the frequency of the oscillator signal generated by the oscillator G2) and the resonant frequency extracted from the signal received from the transponder 10. The determination of the difference between the frequency of the signal for resonating the resonator 14 and the resonant frequency, which is extracted from the signal received from the transponder 10, allows accurate calculation of a variation in the temperature in the tire by using the temperature characteristics of the resonator 14.

It will be further understood by those skilled in the art that the foregoing description is of the preferred embodiments of the present invention, that the sizes or shapes shown in the attached drawings are only examples, and that various changes and modifications may be made to the invention without departing from the spirit and scope thereof.

Although the piezoresistive pressure sensor is used as the pressure sensor in the transponder for the system of detecting tire information according to the exemplary embodiment, the pressure sensor in the transponder is not limited to this type and a pressure sensor of another type may be used. For example, a strain gauge may be used instead of the piezoresistive pressure sensor.

Although the crystal oscillator is used in the resonator for the system of detecting tire information according to the exemplary embodiment, the resonator is not limited to a crystal oscillator. A piezoelectric resonator, such as a piezoelectric ceramic resonator, a piezoelectric single-crystal resonator, or a surface acoustic wave (SAW) resonator, may be used in the transponder. Because the crystal oscillator has a higher Q factor, compared with other piezoelectric single-crystal oscillators, and achieves stable transmission of the resonant frequency, the crystal oscillator is most suitable for the resonator. The piezoelectric single-crystal oscillators include oscillators resulting from processing of piezoelectric single-crystals of lithium tantalate (LiTaO₃), lithium niobate (LiNbO₃), lithium borate (Li₂B₄O₇), potassium niobate (KNbO₃), langasite (La₃Ga₅SiO₁₄), or langanite (La₃Nb_{0.5}Ga_{5.5}O14) or solid solution single crystals of zinc lead niobate-lead titanate.

What is claimed is:

1. A system of detecting tire information, comprising:
a measured value transmitter mounted in a tire of a vehicle; and
a controller provided in a body of the vehicle,
wherein the measured value transmitter includes an antenna, a resonator, a resonant frequency of which is varied in accordance with a temperature of the tire, and a resistive pressure sensor, a resistance of which is varied in accordance with a pressure in the tire, and
wherein the controller is operable to transmit a signal for resonating the resonator and receive a signal having the resonant frequency of the resonator from the measured value transmitter, and the controller is operable to calculate the temperature in the tire based on the signal having the resonant frequency and calculate the pressure in the tire based on a signal level of the signal having the resonant frequency.

2. The system of claim 1, wherein the resonator and the resistive pressure sensor are connected in parallel to an input and output end of the antenna in the measured value transmitter.

3. The system of claim 1, wherein the controller is operable to calculate the pressure in the tire based on a time required for attenuation of the signal level of the signal having the resonant frequency to reach a predetermined level.

4. The system of claim 1, wherein the controller is operable to calculate the temperature in the tire based on a difference between a frequency of the signal for resonating the resonator and the resonant frequency extracted from the signal received from the measured value transmitter.

5. The system of claim 1, wherein the resistive pressure sensor is a piezoresistive pressure sensor.

6. The system of claim 1, wherein the resistive pressure sensor is a strain gauge.
